(19) United States
(12) Patent Application Publication
(10) Pub. No.: US 2026/0098507 A1
(43) Pub. Date: Apr. 9, 2026

(54) PISTON, INTERNAL COMBUSTION ENGINE, AND VEHICLE

(71) Applicant: Isuzu Motors Limited, Yokohama-shi (JP)

(72) Inventor: Takuro MITA, Fujisawa-shi (JP)

(73) Assignee: Isuzu Motors Limited, Yokohama-shi (JP)

(21) Appl. No.: 19/341,093

(22) Filed: Sep. 26, 2025

(30) Foreign Application Priority Data
Oct. 4, 2024 (JP) 2024-175276

(51) Int. Cl. F02F 3/28

(52) U.S. Cl. CPC F02F 3/28

(57) ABSTRACT

A piston includes a top ring groove including a lower inner surface on a bottom side. The lower inner surface is inclined with respect to a radial direction with such an inclination that a part located more on an anti-thrust side is located more on a top side.

### CROSS-REFERENCE TO RELATED APPLICATION

This application is based upon and claims the benefit of priority from prior Japanese Patent Application No. 2024-175276, filed Oct. 4, 2024, the entire contents of which are incorporated herein by reference.

### FIELD

The present disclosure relates to a piston, an internal combustion engine, and a vehicle.

### BACKGROUND

An internal combustion engine or the like mounted in a vehicle or the like includes a piston in which a top ring groove is formed (For example, Jpn. Pat. Appln. KOKAI Publication No. 2018-112275). A top ring is disposed in the top ring groove. By the piston reciprocally moving in a cylinder, the top ring slides on an inner wall surface of the cylinder.

### SUMMARY

A piston includes a top ring groove including a lower inner surface on a bottom side. The lower inner surface is inclined with respect to a radial direction, with such an inclination that a part located more on an anti-thrust side is located more on a top side.

### BRIEF DESCRIPTION OF THE DRAWINGS

FIG. 1 is a schematic diagram illustrating an example of a structure of a vehicle according to an embodiment.

FIG. 2 is a cross-sectional view schematically illustrating, by a cross section, an example of a structure of an internal combustion engine according to the embodiment.

FIG. 3 is a cross-sectional view schematically illustrating, by a cross section, an example of a structure of an outer peripheral surface and the vicinity thereof of a piston according to the embodiment.

FIG. 4 is a diagram illustrating the internal combustion engine according to the embodiment in a state in which a top ring groove is inclined to an anti-thrust side, compared to a neutral state of the piston.

FIG. 5 is a diagram for describing a slide between a top ring and a cylinder at any one of time points of a compression top dead point and a period immediately near the compression top dead point at a time of driving of the piston according to the embodiment.

FIG. 6 is a cross-sectional view schematically illustrating, by a cross section, an example of a structure of an internal combustion engine according to a comparative example.

FIG. 7 is a diagram illustrating the internal combustion engine according to the comparative example in a state in which a top ring groove is inclined to an anti-thrust side, compared to a neutral state of a piston.

FIG. 8 is a diagram for describing a slide between a top ring and a cylinder at any one of time points of a compression top dead point and a period immediately near the compression top dead point at a time of driving of the piston according to the comparative example.

FIG. 9 is a diagram for describing a wear amount of the cylinder according to the comparative example.

FIG. 10 is a diagram for describing a wear amount of the cylinder according to the embodiment.

FIG. 11 is a diagram for describing a wear amount of the top ring according to the comparative example.

FIG. 12 is a diagram for describing a wear amount of the top ring according to the embodiment.

### DETAILED DESCRIPTION

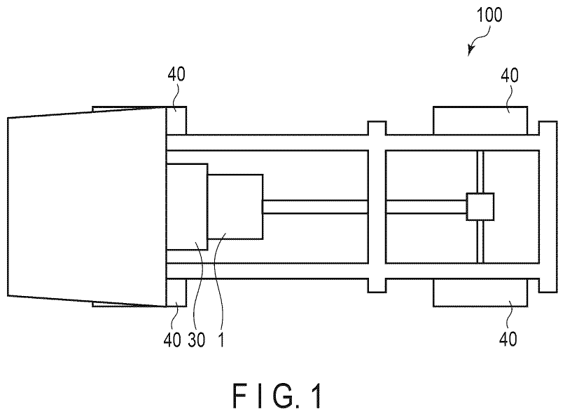

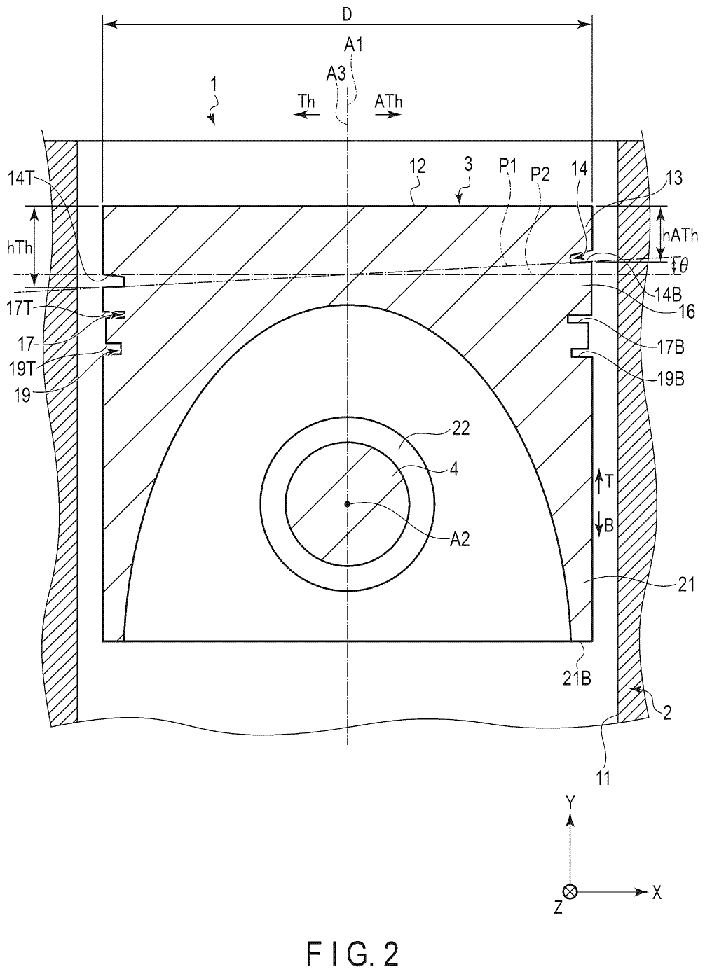

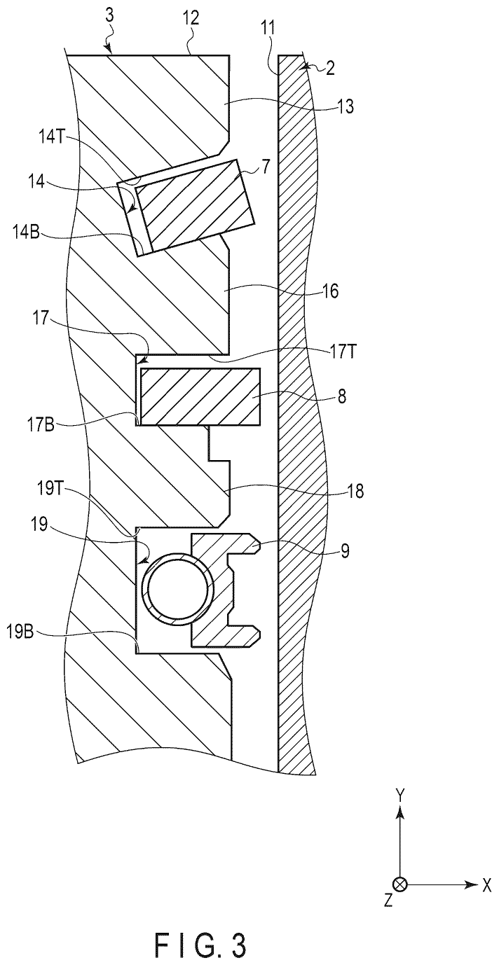

FIG. 1 is a schematic diagram illustrating an example of a structure of a vehicle 100 according to an embodiment. FIG. 2 is a cross-sectional view schematically illustrating an example of a structure of an internal combustion engine 1 according to the embodiment. FIG. 3 is a cross-sectional view schematically illustrating, by a cross section, an example of a structure of an outer peripheral surface and the vicinity thereof of a piston 3 according to the embodiment. As illustrated in FIG. 1, the vehicle 100 includes the internal combustion engine 1, a transmission 30, and at least one wheel 40. In the vehicle 100, if the internal combustion engine 1 is driven, driving force is transmitted to at least one wheel 40 via the transmission 30. As illustrated in FIG. 2 and FIG. 3, the internal combustion engine 1 includes a suction valve (not illustrated), a cylinder 2, the piston 3, a piston pin 4, a crank arm (not illustrated), a crank shaft (not illustrated), and a plurality of piston rings. The internal combustion engine 1 according to embodiment is, for example, a 4-stroke engine that constitutes one cycle including four steps of suction, compression, expansion and exhaust. The internal combustion engine 1 according to the embodiment is, for example, a diesel engine. In this case, the piston rings according to the embodiment include a top ring 7, a second ring 8, and an oil ring 9.

The cylinder 2 extends along a center axis A1 and is formed in a cylindrical shape. The cylinder 2 has an inner wall surface 11. In the cylinder 2, an inside space covered by the inner wall surface 11 is formed.

The piston 3 is disposed in the above-described inside space and is coupled to the crank arm via the piston 4 or the like, which extends in a direction perpendicular to the center axis A1 of the cylinder 2. The crank arm is rotatably provided on the crank shaft (not illustrated). Thereby, the piston 3 is reciprocally movable along the center axis A1 of the cylinder 2 in the inside space. In addition, in parallel with the rotation of the crank arm, the piston 3 makes a so-called oscillation movement, by which the piston 3 pivots around a center axis A2 of the piston pin 4 as a pivotal axis.

In the suction step of the internal combustion engine 1, the piston 3 descends toward the crank shaft side with respect to the suction value, and reaches a bottom dead point. In the compression step, the piston 3 ascends toward the suction valve side from the bottom dead point. At the time of driving of the piston 3, a time point at which the piston has completely ascended in the compression step is referred to as a compression top dead point. In addition, at the compression top dead point and in a period immediately near the compression top dead point at the time of driving of the piston 3, gas in the cylinder 2 is ignited and burnt. In the expansion step, the piston 3 descends to the bottom dead point once again. Then, in the exhaust step, the piston 3 ascends once again from the bottom dead point toward the suction valve side. A time point at which the piston 3 has completely ascended in the exhaust step is referred to as an exhaust top dead point. In this manner, in one cycle including four steps of suction, compression, expansion and exhaust, the piston 3 reciprocates twice between the piston position corresponding to the compression top dead point or the exhaust top dead point, and the bottom dead point. The crank arm rotates twice, in accordance with the reciprocal movement of the piston 3 during one cycle. Then, in the suction step after the exhaust step, the piston 3 descends toward the bottom dead point once again. Note that the compression top dead point and the period immediately near the compression top dead point mean a time point at which the compression step changes to the expansion step and a period immediately near this time point. For example, the period during which the rotational angle of the crank arm falls within the range of ±45 degrees centering on the rotational angle of the crank arm at the time point corresponding to the compression top dead point at the time of driving of the piston 3 is set to be the compression top dead point and the period immediately near the compression top dead point. Note that the rotational angle of the crank is an angle formed by a straight line that extends along the center axis A2 of the cylinder 2 and extends from the crank shaft side toward the suction valve side, and the crank arm extending from one end side coupled to the crank shaft toward the other end side. Note that the compression top dead point and the period immediately near the compression top dead point may be, for example, a period during which the piston 3 is located on the top dead point side with respect to a position at which the distance from the top dead point and the distance from the bottom dead point are equal, in the compression step or the expansion step. Thus, the exhaust top dead point and the period immediately near the exhaust top dead point are not included in the compression top dead point and the period immediately near the compression top dead point.

Hereinafter, one side of a center axis A3 of the piston 3 is referred to as a top side T, and the opposite side to the top side T is referred to as a bottom size B. In the piston 3, for example, a piston top surface 12, a top land 13, a top ring groove 14, a second land 16, a second ring groove 17, a third land 18, an oil ring groove 19 and a piston skirt 21 are formed in the named order from the top side T. The piston top surface 12 is an end surface on the top side T in the piston 3, and faces toward the top side T. The piston skirt 21 forms an end surface 21B on the bottom side B in the piston 3, and the end surface 21B on the bottom side B that the piston skirt 21 forms faces toward the bottom side B.

The top ring groove 14 is formed of a plurality of surfaces. Of the surfaces forming the top ring groove 14, an end surface on the top side T is referred to as an upper inner surface 14T of the top ring groove 14, and an end surface on the bottom side B is referred to as a lower inner surface 14B of the top ring groove 14. The top ring 7 is disposed in the top ring groove 14. The top ring 7 includes two end portions (not illustrated), and is formed to extend in a C shape from the end portion on one side to the end portion on the other side. An end gap (not illustrated) is formed between the two end portions. The two end portions face each other with the end gap being interposed. By the piston 3 reciprocally moving in the cylinder 2, the top ring 7 slides over the inner wall surface 11 of the cylinder 2. The top ring 7 rotates relative to the piston 3, with the center axis A3 of the piston 3 being the rotational axis.

A groove may be formed in an outer peripheral surface of the second land 16. The second ring groove 17 is formed of a plurality of surfaces including an end surface 17T on the top side T and an end surface 17B on the bottom side B. The third land 18 is formed in a columnar shape. The oil ring groove 19 is formed of a plurality of surfaces including an end surface 19T on the top side T and an end surface 19B on the bottom side B. In the piston skirt 21 of the piston 3, each of a pair of piston pin bosses (not illustrated) projects toward the inner peripheral side. In addition, in the piston skirt 21, a piston pin hole 22, in which the piston pin 4 is inserted, is formed in each of the piston pin bosses. The center axis A2 of the piston pin 4 is coaxial or substantially coaxial with the center axis of the piston pin hole 22.

In the present embodiment, the piston 3 used in the diesel engine, among internal combustion engines 1, is described as an example, but the embodiment is not limited to this. The piston 3 may be used in other internal combustion engines 1 such as a gasoline engine, aside from the case where the piston 3 is used in the diesel engine. However, the number of ring grooves formed in the piston 3 varies in accordance with the internal combustion engine 1 in which the piston 3 is used.

In addition, the center axis A3 of the piston 3 may be coaxial with the center axis of the top land 13. Aside from this, the center axis A3 of the piston 3 may be any one of structures of a central part in height of the piston 3, which do not have an eccentric or elliptic shape, among structures of the piston 3. Specifically, the structure of the central part in height of the piston 3 is, for example, the center axis of the second land 16, third land 18 or piston skirt 21. Here, the center of a cross section of the piston 3, which is cut by a plane that is perpendicular to the center axis of the top land 13, second land 16, third land 18 or piston skirt 21 and includes the center axis of the piston pin hole 22, is defined as the center of the piston pin hole 22. The center axis A3 of the piston 3 may be coaxial with an axis that is perpendicular to the center axis of the piston pin hole 22 and passes through the center of the piston pin hole 22. Note that the cross section illustrated in FIG. 2 and FIG. 3 is an entirety or a part of a cross section in a case where the internal combustion engine 1 is cut along a plane that includes the center of the piston pin hole 22 and is perpendicular to the center axis of the piston pin hole 22. Hereinafter, a direction around the center axis A3 of the piston 3 is defined as a circumferential direction, and a direction that is perpendicular to the center axis A3 of the piston 3 and the circumferential direction of the piston 3 is defined as a radial direction.

Here, a surface extending along the radial direction of the piston 3 is referred to as a reference surface. The reference surface is, for example, the end surface 21B on the bottom side B, which the piston skirt 21 forms. In a case where the end surface 21B extends along the radial direction, the end surface 21B may be called a working reference surface. The reference surface may be the piston top surface 12. Alternatively, the reference surface may be the end surface 17T on the top side T or the end surface 17B on the bottom side B of the second ring groove 17. Alternatively, the reference surface may be the end surface 19T on the top side T or the end surface 19B on the bottom side B of the oil ring groove 19. Alternatively, the reference surface may be an imaginary plane that includes the center axis of the piston pin hole 22 and is perpendicular to the center axis of the third land 18. Alternatively, the reference surface may be some other surface formed in the piston 3, or some other imaginary plane.

An inclination angle at a time when the piston 3 is inclined from the state in which the center axis A3 of the piston 3 extends along the center axis A1 of the cylinder 2 is referred to as an oscillation angle φ of the piston 3. FIG. 2 illustrates the piston 3 in the state in which the center axis A3 of the piston 3 is not inclined with respect to the center axis A1 of the cylinder 2 and coincides with the center axis A1 of the cylinder 2. This state of the piston 3 is referred to as a neutral state of the piston 3.

The piston 3 makes an oscillation movement and receives a lateral pressure from the cylinder 2. In the internal combustion engine 1, a maximum lateral pressure occurs immediately after the compression top dead point. At this time, of the parts of the piston 3, a part formed on the bottom side B with respect to the piston pin hole 22 is inclined toward one side from the neutral state, and a part formed on the top side A with respect to the piston pin hole 22 is inclined toward the other side opposite to the one side from the neutral state. Hereinafter, at the compression top dead point and in the period immediately near the compression top dead point, the side, toward which the part formed on the bottom side B with respect to the piston pin hole 22 is inclined, is referred to as a thrust side Th, and the side, toward which the part formed on the top side T with respect to the piston pin hole 22 is inclined, is referred to as an anti-thrust side ATh. For example, since the top ring groove 14 is the part formed on the top side T with respect to the piston pin hole 22, the top ring groove 14 is inclined toward the anti-thrust side ATh, compared to the neutral state, at the compression top dead point and in the period immediately near the compression top dead point.

Here, in FIG. 2, a direction along the center axis A1 of the cylinder 2 is defined as a Y-axis direction, a direction, which is perpendicular to the Y-axis direction and in which the piston pin 4 extends, is defined as a Z-axis direction, and a direction perpendicular to the Y-axis direction and the Z-axis direction is defined as an X-axis direction. In regard to the X-axis direction, the anti-thrust side ATh is defined as a positive direction of the X-axis direction, and the thrust side Th is defined as a negative direction of the X-axis direction. In addition, the suction valve side is defined as a positive direction of the Y-axis direction, and the crank shaft side is defined as a negative direction of the Y-axis direction. Besides, the depth side with respect to the drawing sheets of FIG. 2 and FIG. 3 is defined as a positive direction of the Z-axis direction, and the near side is defined as a negative direction of the Z-axis direction.

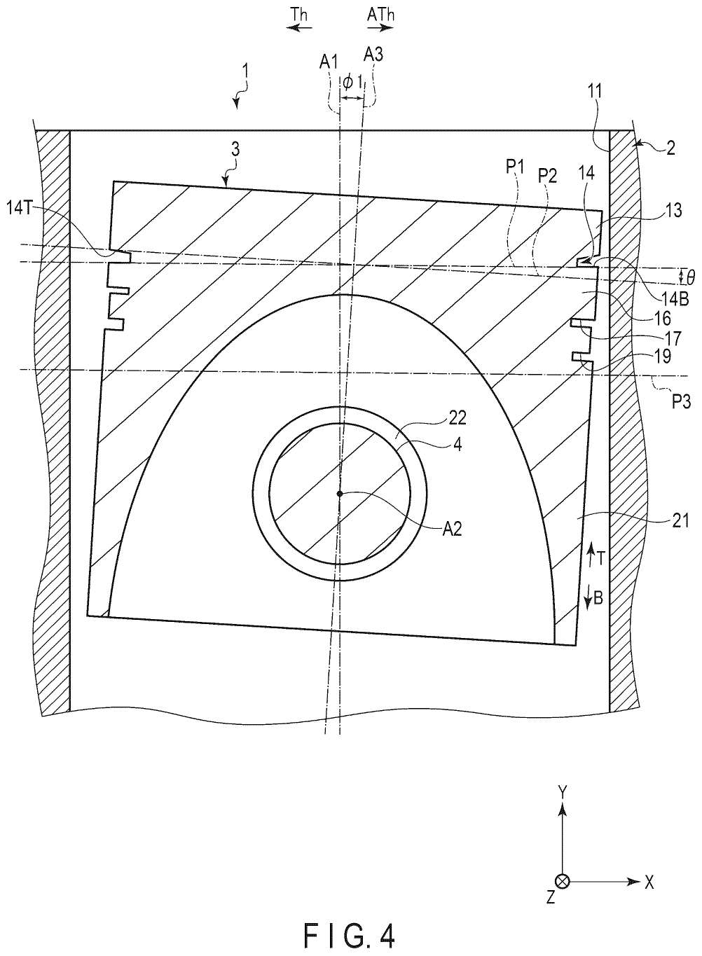

FIG. 4 is a diagram illustrating the internal combustion engine 1 according to the embodiment in a state in which the top ring groove 14 is inclined to the anti-thrust side ATh, compared to the neutral state of the piston 3. In FIGS. 2 and 4, a plane P1 is an imaginary plane extending along the lower inner surface 14B of the top ring groove 14, and is inclined with respect to the radial direction, with such an inclination that a part located more on the anti-thrust side ATh is located more on the top side T.

In FIG. 2 and FIG. 4, a plane P2 is an imaginary plane P2 extending along the radial direction. The lower inner surface 14B of the top ring groove 14 is inclined with respect to the radial direction with such an inclination that a part located more on the anti-thrust side ATh is located more on the top side T. Specifically, as illustrated in FIG. 2 and FIG. 4, the plane P1 is inclined with respect to the plane P2 extending along the radial direction, with such an inclination that a part located more on the anti-thrust side ATh is located more on the top side T. Here, an angle formed between the plane P1 and the plane P2 extending along the radial direction is defined as an inclination angle θ of the lower inner surface 14B of the top ring groove 14. In addition, in FIG. 4, a set angle φ1 is an angle that is preset at the time of designing the piston 3, and is an angle that is assumed to be an inclination angle of the piston 3 at any one of time points of the compression top dead point and the period immediately near the compression top dead point. The piston 3 illustrated in FIG. 4 is inclined by the set angle φ1 with respect to the center axis A1 of the cylinder 2. Typically, the set angle φ1 is set at a value in a range of 0.05 degrees to 0.5 degrees. The lower inner surface 14B of the top ring groove 14 is provided to extend such that the inclination angle θ of the lower inner surface 14B coincides or substantially coincides with the set angle φ1. In addition, in FIG. 4, a plane P3 is an imaginary plane perpendicular to the center axis A1 of the cylinder 2.

Among the oscillation angles φ at the compression top dead point and in the period immediately near the compression top dead point at the time of driving of the piston 3, if there is an oscillation angle that coincides with the set angle φ1, this oscillation angle φ coincides with the inclination angle θ. Note that there is a case where among the oscillation angles φ at the compression top dead point and in the period immediately near the compression top dead point at the time of driving of the piston 3, the oscillation angle that coincides with the set angle φ1 is not present.

In FIG. 2, a distance hTh is a distance along the center axis A3 of the piston 3 between an end portion on the thrust side Th of the lower inner surface 14B of the top ring groove 14 and the piston top surface 12. A distance hATh is a distance along the center axis A3 of the piston 3 between an end portion on the anti-thrust side ATh of the lower inner surface 14B of the top ring groove 14 and the piston top surface 12. A distance D is a distance between an end portion on the thrust side Th and an end portion on the anti-thrust side ATh of the piston top surface 12. The inclination angle θ is a value based on the distance hTh, distance hATh and distance D. Specifically, the inclination angle θ is calculated by substituting the distance hTh, distance hATh and distance D in equation (1−A) below.

$$θ = {tan}^{- 1} ( \frac{hTh - hATh}{D} ) \qquad ( 1 - A )$$

In addition, in the top ring groove 14, a middle point between an end portion on the thrust side Th of the upper surface 14T and an end portion on the thrust side Th of the lower inner surface 14B is defined as a point A (not illustrated). Further, in the top ring groove 14, a middle point between an end portion on the anti-thrust side ATh of the upper surface 14T and an end portion on the anti-thrust side ATh of the lower inner surface 14B is defined as a point B (not illustrated). The inclination angle θ may be calculated based on a distance A along the center axis A3 of the piston 3 between the piston top surface 12 and the point A, and a distance B along the center axis A3 of the piston 3 between the piston top surface 12 and the point B. For example, the inclination angle θ may be calculated by substituting, in equation (1−A), the distance A in place of the distance hTh, and the distance B in place of the distance hATh.

An angle formed between a surface along a part on the thrust side Th of the upper surface 14T of the top ring groove 14, and the plane P1, may be set at a freely selected angle. Similarly, an angle formed between a surface along a part on the anti-thrust side ATh of the upper surface 14T of the top ring groove 14, and the plane P1 along the lower inner surface 14B of the top ring groove 14, may be set at a freely selected angle.

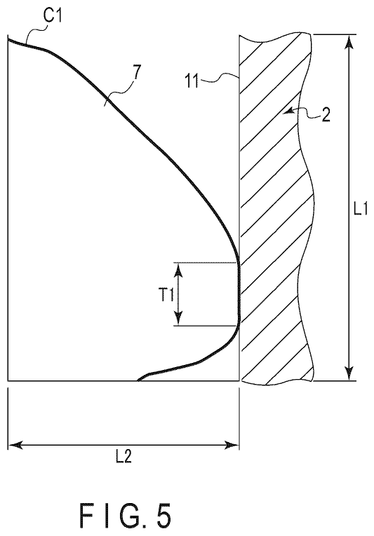

Next, the advantageous effects of the piston 3 constructed as in the above-described embodiment are described. FIG. 5 is a diagram for describing a slide between an outer peripheral surface of the top ring 7 and the cylinder 2 at any one of time points of the compression top dead point and the period immediately near the compression top dead point at a time of driving of the piston 3 according to the embodiment. In FIG. 5, a direction perpendicular to the axial direction along the cylinder 2 corresponds to the radial direction of the piston 3. In FIG. 5, a curve C1 indicates a part on the anti-thrust side ATh of the outer peripheral surface of the top ring 7, at any one of time points of the compression top dead point and the period immediately near the compression top dead point. In the curve C1, a contact range T1 indicates a range of a part of the outer peripheral surface of the top ring 7, which comes in contact with the inner wall surface 11 of the cylinder 2, at the time of driving of the piston 3. Note that an actual dimension of a part indicated by an arrow L1 in the axial direction in FIG. 5 is a dimension that is about 100 times greater than an actual dimension indicated by an arrow L2 in the radial direction. Specifically, the outer peripheral surface of the top ring 7 illustrated in FIG. 5 is illustrated by enlarging the dimension in the radial direction relative to the dimension in the axial direction.

The plane P1 is inclined such that a part located more on the anti-thrust side ATh is located more on the top side T. In addition, the lower inner surface 14B of the top ring groove 14 is provided to extend such that the inclination angle θ of the lower inner surface 14B coincides or substantially coincides with the set angle φ1. Thereby, in a case where the oscillation angle φ coincides with the set angle φ1 at any one of time points of the compression top dead point and the period immediately near the compression top dead point, as illustrated in FIG. 4, the plane P1 is parallel or substantially parallel to the plane P3. In addition, as indicated by the curve C1, in the part on the anti-thrust side ATh of the outer peripheral surface of the top ring 7, a part included in a contact range T1 faces the inner wall surface 11 of the cylinder 2 in parallel or substantially in parallel, and slides at an appropriate angle. Furthermore, at a time when the plane P1 becomes parallel or substantially parallel to the plane P3, the part included in the contact range in the part on the thrust side Th of the outer peripheral of the top ring 7 also faces the inner wall surface 11 in parallel or substantially in parallel, as indicated by the curve C1 in FIG. 5, and slides at an appropriate angle. In this manner, both the part on the thrust side Th and the part on the anti-thrust side ATh of the outer peripheral surface of the top ring 7 slide on the inner wall surface 11 at appropriate angles. Note that even if the oscillation angle φ does not coincide with the set angle φ1 at the compression top dead point and in the period immediately near the compression top dead point, an absolute value between the oscillation angle φ and the inclination angle θ becomes smaller than in the case of not the compression top dead point or the period immediately near the compression top dead point. Accordingly, at the compression top dead point and in the period immediately near the compression top dead point, both the part on the thrust side Th and the part on the anti-thrust side ATh of the outer peripheral surface of the top ring 7 slide on the inner wall surface 11 at appropriate angles.

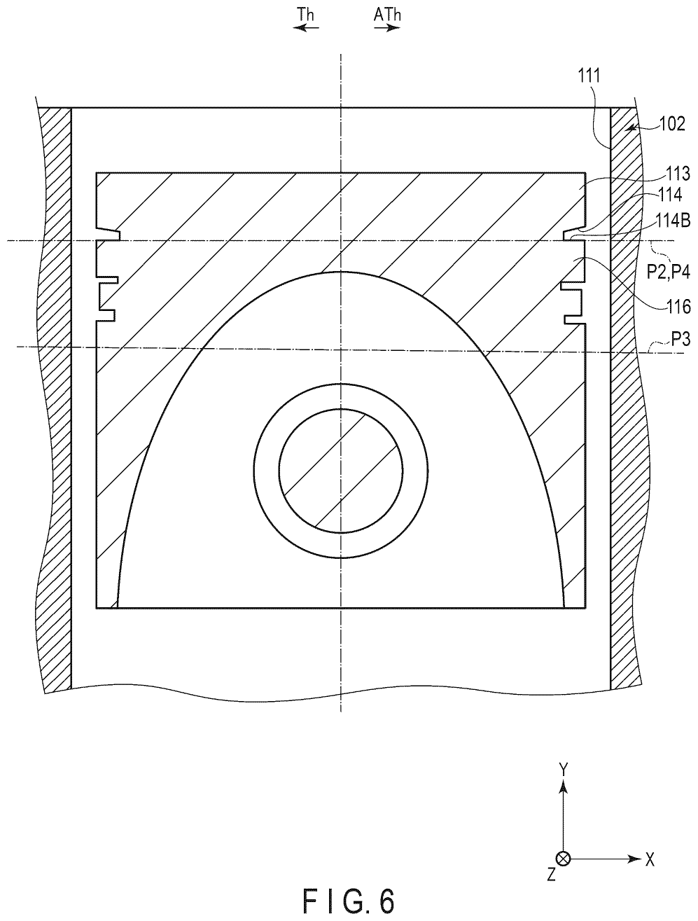

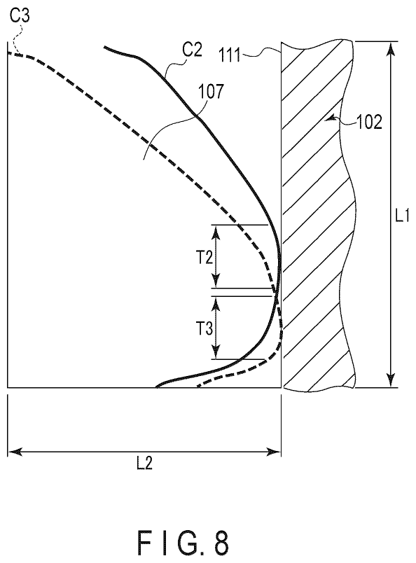

Here, an internal combustion engine including a piston including a lower inner surface of a top ring groove, which is provided to extend along the radial direction, is described as a comparative example of the structure according to the embodiment. FIG. 6 is a cross-sectional view schematically illustrating, by a cross section, an example of a structure of the internal combustion engine according to the comparative example. In FIG. 6, the piston in the neutral state is illustrated. In the piston in the internal combustion engine according to the comparative example, as illustrated in FIG. 6, a top land 113, a top ring groove 114 including a lower inner surface 114B of the top ring groove, and a second land 116 are formed. These structures are different from the structures of the top land 13, top ring groove 14 including the lower inner surface 14B of the top ring groove, and second land 16 of the piston 3 according to the embodiment. It is assumed that the other structures of the piston according to the comparative example are identical to the structures of the piston 3 according to the embodiment. A top ring 107 (see FIG. 8 to be described later) is disposed in the top ring groove 114. In addition, the internal combustion engine according to the comparative example includes a cylinder 102 including an inner wall surface 111. In FIG. 6, a plane P4 is a plane P4 extending along the lower inner surface 114B of the top ring groove 114.

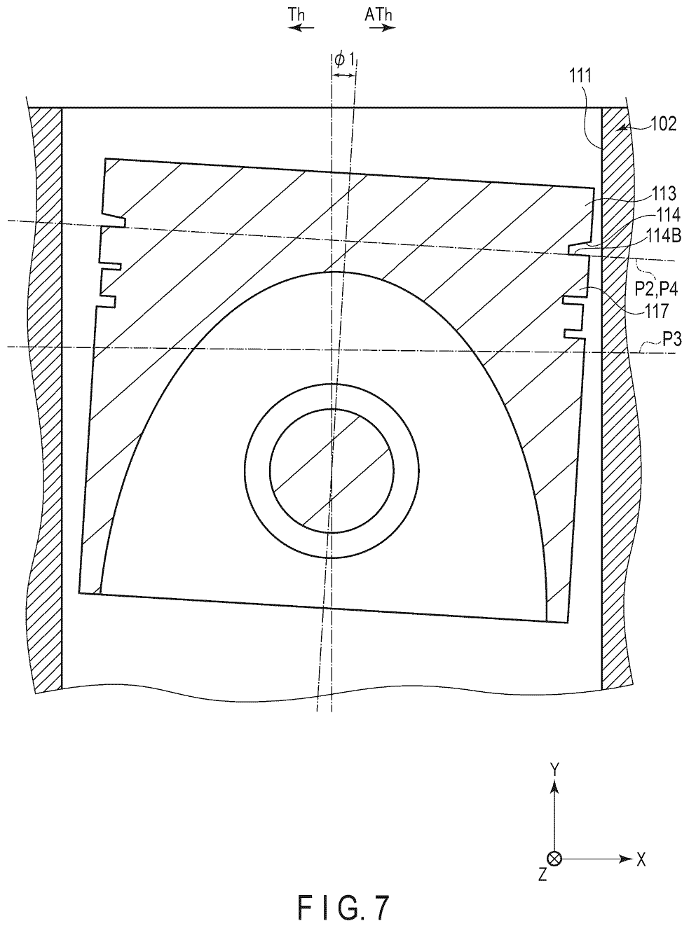

FIG. 7 is a diagram illustrating the internal combustion engine according to the comparative example in a state in which the top ring groove 114 is inclined to the anti-thrust side ATh, compared to the neutral state of the piston. The piston illustrated in FIG. 7 is inclined by the set angle φ1 with respect to the center axis of the cylinder 102. Since the lower inner surface 14B of the top ring groove extends along the radial direction, the plane P4 can be the same plane as the plane P2 extending along the radial direction, as illustrated in FIG. 6 and FIG. 7.

FIG. 8 is a diagram for describing a slide between the top ring 107 and the cylinder 102 at any one of time points of the compression top dead point and the period immediately near the compression top dead point at a time of driving of the piston according to the comparative example. In FIG. 8, a direction perpendicular to the axial direction along the cylinder 102 corresponds to the radial direction of the piston. In FIG. 8, a curve C2 expressed by a solid line indicates a part on the anti-thrust side ATh of the outer peripheral surface of the top ring 107, at any one of time points of the compression top dead point and the period immediately near the compression top dead point. In the curve C2, a contact range T2 indicates a range of a part of the outer peripheral surface of the top ring 107, which comes in contact with the inner wall surface 111 of the cylinder 102, at the time of driving of the piston. In addition, in FIG. 8, a curve C3 expressed by a broken line indicates a part on the thrust side Th of the outer peripheral surface of the top ring 107, at any one of time points of the compression top dead point and the period immediately near the compression top dead point. In the curve C3, a contact range T3 indicates a range of a part of the outer peripheral surface of the top ring 107, which comes in contact with the inner wall surface 111 of the cylinder 102, at the time of driving of the piston. Note that, like FIG. 5, an actual dimension of a part indicated by an arrow L1 in the axial direction in FIG. 8 is a dimension that is about 100 times greater than an actual dimension indicated by an arrow L2 in the radial direction. Specifically, the outer peripheral surface of the top ring 107 in FIG. 8 is illustrated by enlarging the dimension in the radial direction relative to the dimension in the axial direction.

In the piston according to the comparative example, the plane P4 extending along the lower inner surface 114B of the top ring groove 114 is provided to extend along the radial direction. Thus, as illustrated in FIG. 6, in a case where the piston is in the neural state, the plane P4 is parallel or substantially parallel to the plane P3. On the other hand, as illustrated in FIG. 7, in the case where the oscillation angle φ is the set angle φ1 at any one of time points of the compression top dead point and the period immediately near the compression top dead point, the plane P4 extending along the lower inner surface 114B of the top ring groove 114 is neither parallel nor substantially parallel to the plane P3. Thus, as indicated by the curve C2 in FIG. 8, only a portion of the part included in the contact range T2 in the part on the anti-thrust side ATh of the outer peripheral surface of the top ring 107 is opposed to the inner wall surface 111 of the cylinder 102 in parallel or substantially in parallel. In addition, as indicated by the curve C3 in FIG. 8, only a portion of the part included in the contact range T3 in the part on the thrust side Th of the outer peripheral surface of the top ring 107 is opposed to the inner wall surface 111 of the cylinder 102 in parallel or substantially in parallel. In this manner, the outer peripheral surface of the top ring 107 according to the comparative example does not slide on the inner wall surface 11 at an appropriate angle.

From the above, in the structure of the piston 3 according to the embodiment, compared to the structure of the comparative example, the top ring 7 slides on the cylinder 2 at the appropriate angle. Thereby, the frictional loss can be decreased.

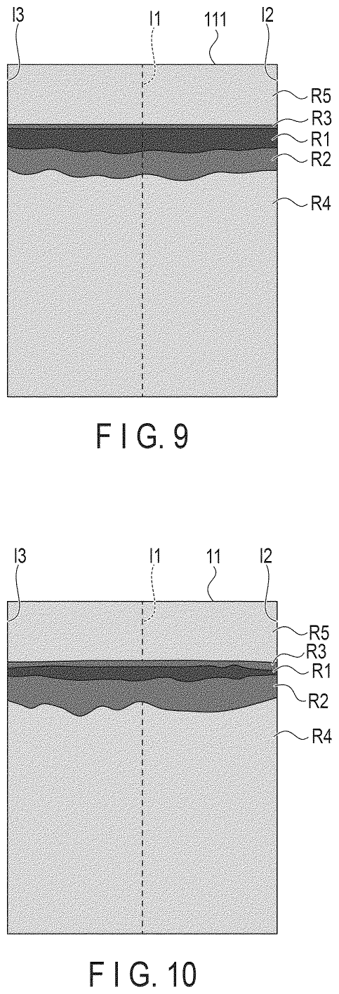

Hereinafter, the wear amount of the inner wall surface 11 of the cylinder 2 according to the embodiment and the wear amount of the inner wall surface 111 of the cylinder 102 according to the comparative example are compared with reference to FIG. 9 and FIG. 10. FIG. 9 is a diagram for describing the wear amount of the cylinder 102 according to the comparative example. FIG. 10 is a diagram for describing the wear amount of the cylinder 2 according to the embodiment. FIG. 9 illustrates the inner wall surface 111 of the cylinder 102 according to the comparative example, and FIG. 10 illustrates the inner wall surface 11 of the cylinder 2 according to the embodiment. In FIG. 9 and FIG. 10, a broken line 11 indicates a part on the anti-thrust side ATh of the inner wall surface of the cylinder, and line segments 12 and 13 indicate parts on the thrust side Th of the inner wall surface of the cylinder. In addition, in FIG. 9 and FIG. 10, wear amounts corresponding to parts of the inner wall surface are illustrated. The inner wall surface illustrated in FIG. 9 and FIG. 10 is divided into a region R1, a region R2, a region R3, a region R4 and a region R5. The wear amount of the part included in the region R1 is largest on the inner wall surface. The wear amounts of the parts included in the region R2 and region R3 are smaller than the wear amount of the part included in the region R1. The wear amounts of the parts included in the region R4 and region R5 are smaller than the wear amounts of the parts included in the region R2 and region R3.

In general, if the piston and the top ring begin to move relative to the cylinder from the state in which the top ring is at rest on the cylinder at the compression top dead point, a mixture lubrication state occurs, and the cylinder and the top ring tend to easily wear. In addition, in the internal combustion engine, immediately after the compression top dead point, a maximum lateral pressure occurs and the force of the top ring pushing the cylinder increases, and thus the cylinder and the top ring tend to easily wear. Since the region R1 includes the part of the inner wall surface, which faces the top ring at the compression top dead point and in the period immediately near the compression top dead point, the wear amount in the region R1 is larger than in the other parts of the inner wall surface. However, as illustrated in FIG. 9 and FIG. 10, on the inner wall surface 11 of the cylinder 2 according to the embodiment, compared to the inner wall surface 111 of the cylinder 102 according to the comparative example, the area of the region R1 is small. In this manner, in the structure of the piston 3 according to the embodiment, compared to the structure of the comparative example, the wear amount of the inner wall surface 11 of the cylinder 2 can be decreased.

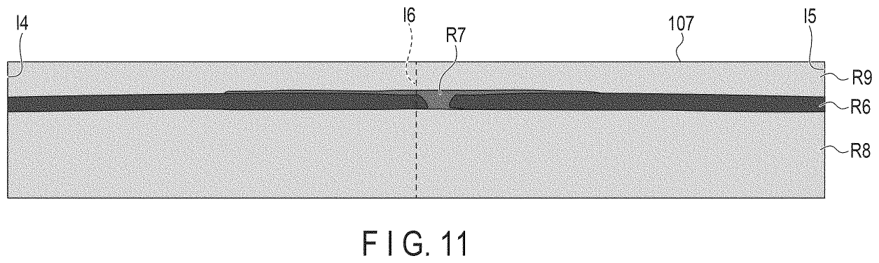

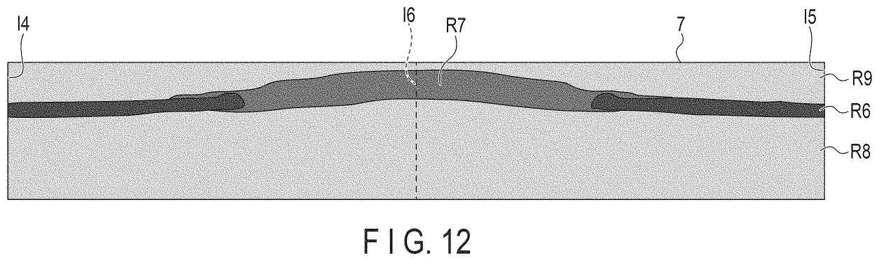

In addition, hereinafter, the wear amount of the top ring 7 according to the embodiment and the wear amount of the top ring 107 according to the comparative example are compared with reference to FIG. 11 and FIG. 12. FIG. 11 is a diagram for describing the wear amount of the top ring 107 according to the comparative example. FIG. 12 is a diagram for describing the wear amount of the top ring 7 according to the embodiment. FIG. 11 illustrates an outer peripheral surface of the top ring 107 according to the comparative example, and FIG. 12 illustrates an outer peripheral surface of the top ring 7 according to the embodiment. In FIG. 11 and FIG. 12, line segments 14 and 15 correspond to two end portions of the outer peripheral surface of the top ring, which are opposed to each other with the end gap being interposed. In addition, a broken line 16 represents a part of the outer peripheral surface of the top ring 7, which is located between the two end portions that are opposed to each other with the end gap being interposed. In addition, in FIG. 11 and FIG. 12, wear amounts corresponding to parts of the outer peripheral surface of the top ring are illustrated. The outer peripheral surface of the top ring illustrated in FIG. 11 and FIG. 12 is divided into a region R6, a region R7, a region R8 and a region R9. The wear amount in the part included in the region R6 of the outer peripheral surface of the top ring is largest in the outer peripheral surface of the top ring. The wear amount in the part included in the region R7 of the outer peripheral surface of the top ring is smaller than the wear amount in the part included in the region R6. The wear amount in the parts included in the region R8 and region R9 of the outer peripheral surface of the top ring is smaller than the wear amount in the part included in the region R7.

The top ring rotates relative to the piston around the center axis of the piston as the rotational axis. Thus, the position of the top ring, which slides on the inner wall surface of the cylinder, varies, and wear occurs on a wide area of the outer peripheral surface of the top ring. However, as illustrated in FIG. 11 and FIG. 12, the area of the region R6 is smaller on the outer peripheral surface of the top ring 7 according to the embodiment than on the outer peripheral surface of the top ring 107 according to the comparative example. In this manner, in the structure of the piston 3 according to the embodiment, compared to the structure of the comparative example, the wear amount of the outer peripheral surface of the top ring 7 can be decreased.

From the above, in the structure of the piston 3 according to the embodiment, compared to the structure of the comparative example, since the top ring 7 slides on the cylinder 2 at an appropriate angle, the wear amounts of the cylinder 2 and the top ring 7 can be decreased. Thereby, in the structure of the piston 3 according to the embodiment, the performance of the top ring 7 and cylinder 2 can be maintained in the driving over a longer time, than in the structure of the comparative example.

Note that in the embodiment the lower inner surface 14B of the top ring groove 14 is configured to extend such that the inclination angle θ of the lower inner surface 14B coincides or substantially coincides with the set angle φ1, but the embodiment is not limited to this. The inclination angle θ of the lower inner surface 14B of the top ring groove 14 may be set to a freely selected angle, if the angle can decrease the wear amounts of the cylinder 2 and top ring 7.

Additionally, according to the embodiment, in addition to the above-described advantageous effects, there can be provided the internal combustion engine 1 including the piston 3 that can decrease the wear amounts of the cylinder 2 and top ring 7. Moreover, the vehicle 100 including the internal combustion engine 1 can be provided.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A piston comprising a top ring groove including a lower inner surface on a bottom side,
wherein the lower inner surface is inclined with respect to a radial direction, with such an inclination that a part located more on an anti-thrust side is located more on a top side.

2. The piston of claim 1, wherein an inclination angle formed between the lower inner surface and a plane extending along the radial direction coincides with an oscillation angle at any one of time points of a compression top dead point and a period immediately near the compression top dead point.

3. The piston of claim 1, further comprising a piston skirt including an end surface on the bottom side of the piston skirt, the end surface being provided to extend along the radial direction, and the piston skirt being provided on the bottom side with respect to the top ring groove.

4. The piston of claim 1, further comprising a piston top surface formed on the top side with respect to the top ring groove, and provided to extend along the radial direction.

5. An internal combustion engine comprising:
the piston of claim 1;
a top ring disposed in the top ring groove of the piston; and
a cylinder in which the top ring is slidably disposed.

6. A vehicle comprising the internal combustion engine of claim 5.
